(19) United States
(12) Patent Application Publication
(10) Pub. No.: US 2011/0026751 A1
(43) Pub. Date: Feb. 3, 2011

(54) High Acoustic Compliance Device for Loudspeaker Systems

(76) Inventor: Stefan Roman Hilbowicki, Toronto (CA)

Correspondence Address: ELIAS BORGES, 56 Aberfoyle Crescent, Suite 840, Canada, ON, M8X2W4, CA

(21) Appl. No.: 12/845,069

(22) Filed: Jul. 28, 2010

Related U.S. Application Data
(60) Provisional application No. 61/229,048, filed on Jul. 28, 2009.

(51) Int. Cl. H04R 1/02

(52) U.S. Cl. 381/345

(57) ABSTRACT

There is provided a device for propagating acoustic vibrations through an environment. The device includes a low pressure chamber containing a volume of reduced pressure relative to the environment. A movable wall is formed on the low pressure chamber, said movable wall having an ambient side facing the environment and a low pressure side facing the volume of reduced pressure. The movable wall is sufficiently biased towards the environment and away from the volume of reduced pressure such that the movable wall can freely vibrate back and forth relative to the volume of reduced pressure in response to acoustic vibrations impinging on the ambient side of the movable wall. The device has the acoustical compliance of a device of far larger volume.

### CROSS REFERENCE TO RELATED APPLICATION

This application claims priority from U.S. Provisional Application Ser. No. 61/229,048 filed Jul. 28, 2009, the entirety of which is incorporated herein by reference.

### FIELD OF THE INVENTION

The invention relates generally to electro-acoustic transducers and loudspeakers.

### BACKGROUND OF THE INVENTION

Loudspeaker enclosure prevents acoustic energy radiated from the back of the transducer diaphragm from interfering with the direct energy. Some loudspeakers may have open enclosure but they do not perform efficiently at low frequencies. Conventional enclosures for loudspeakers have a predetermined volume. The enclosure contains one or more transducers and one or more openings or cavities. All openings communicating with outside environment radiate sound. The air coming in and out of an enclosure changes the air pressure inside it. The smaller enclosure size and the lower the frequency the larger the internal pressure changes are required. The air within an enclosure is moved by a diaphragm or cone propelled typically by an electromagnetic transducer. This explains briefly why smaller enclosure and lower radiated frequency requires more electrical power what is expressed by well known equation (1)

η₀=k·F₃³·V_{B} (1)

Where:
η₀=reference efficiency
k=system constant
F₃=cutoff low frequency
V_{B}=internal box volume

The efficiency is defined as the ratio of acoustic power radiated by loudspeaker to electric power supplied to loudspeaker. Equation (1) assume that the enclosure is filled with air or other gasses under ambient atmospheric pressure. This assumption is necessary because otherwise loudspeaker cone would significantly offset from its normal position and be destroyed.

There has always been a demand for small loudspeakers and loudspeakers efficiently reproducing low frequencies in particular. Majority of engineering efforts was devoted to increase system constant k. One example is vented system versus sealed system or band-pass system. This group of improvements exchanges system bandwidth for efficiency. The efficiency increases are relatively small and paid by system complexity and cost. One of probably the most comprehensive papers devoted to loudspeaker efficiency was written by J. Harrison. It rules out the existence of any “magic” alignment and sets limits on constant k.

U.S. Pat. Nos. 5,748,759 and 4,722,517 disclose how to reduce the loading effect of an enclosure internal compliance on loudspeaker cone using suspensions with negative compliances. The patents are not specific about the level of improvement they provide. These techniques are relatively complex, they need complex active controlling systems and they are not suitable for systems with multiple cavities.

The other known approach to bypass the limitations imposed by equation (1) is to control the environment within an enclosure. Ott—U.S. Pat. No. 4,004,094, Czerwinski—U.S. Pat. No. 4,101,736 or Marrs—U.S. Pat. No. 4,450,929 fills the portion of an enclosure with a gas at the point of its saturation. These concepts require substances which are not environmentally friendly like Freon and need complex controlling systems essential for their proper operation. In addition this techniques aim at achieving the highest possible compliances what is not always desirable. Sullivan—U.S. Pat. No. 2,797,766 considers filling the enclosure with special gas also.

### SUMMARY OF THE INVENTION

In accordance with one aspect of the present invention, there is provided a device for use in acoustic systems in an environment. The device includes a low pressure chamber containing a volume of reduced pressure relative to the environment. The device further includes a movable wall having an ambient side acoustically coupled to the environment and a low pressure side acoustically coupled to the low pressure chamber. The movable wall is sufficiently biased towards the ambient side to permit the movable wall to freely vibrate between the ambient and low pressure sides. The net effect is a device having an acoustical volume much higher than its actual physical volume.

In accordance with another aspect of the present invention, there is provided a device for propagating acoustic vibrations through an environment. The device includes a low pressure chamber containing a volume of reduced pressure relative to the environment. A movable wall is formed on the low pressure chamber, said movable wall having an ambient side facing the environment and a low pressure side facing the volume of reduced pressure. The movable wall is sufficiently biased towards the environment and away from the volume of reduced pressure such that the movable wall can freely vibrate back and forth relative to the volume of reduced pressure in response to acoustic vibrations impinging on the ambient side of the movable wall.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 shows a section of prior art loudspeaker in sealed enclosure.

FIG. 2 is a graphic and simplified representation of the system in FIG. 1 showing only transducer radiating surface and enclosure.

FIG. 3a is a sectional view of preferred embodiment of the present invention employing an air spring.

FIG. 3b is a perspective view, partially in section, of a preferred embodiment of the present invention employing an air spring.

FIG. 4a is a sectional view of sealed box system using invented device.

FIG. 4b is a perspective view partly in section of sealed box system using invented device.

FIG. 5a is a sectional view of a vented box system using invented device.

FIG. 5b is a sectional view in perspective of a vented box system using invented device.

FIG. 6 is a sectional perspective view of sealed box system using multiple invented devices.

FIG. 7 is a sectional perspective view of vented box system using multiple invented devices.

FIG. 8 is a sectional perspective view of two invented devices joined to form dual assembly.

FIG. 9 is an example of larger assembly of dual devices.

FIG. 10a is a sectional view of a sealed box system with invented device embedded in driver construction.

FIG. 10b is a sectional view in perspective of a sealed box system with invented device embedded in driver construction.

FIG. 11a is a sectional view of a passive radiator system with invented device embedded in driver and passive radiator constructions.

FIG. 11b is a sectional view in perspective of a passive radiator system with invented device embedded in driver and passive radiator constructions.

FIGS. 12a, 12b, and 12c and illustrates the concept of replacing air spring with a mechanical spring.

FIG. 13 illustrates another embodiment of present invention employing vacuum and mechanical spring.

FIG. 14a is a perspective view of another embodiment of the present invention showing a low pressure chamber in the form of a bellows in its ambient orientation.

FIG. 14b is a perspective view of the embodiment shown in FIG. 14a with the interior of the bellow being evacuated.

FIG. 15 is a perspective view partly in section of the embodiment shown in FIG. 14 with an additional spring for biasing.

FIG. 16a is a perspective view of another embodiment of present invention employing vacuum and spring properties of the walls of a tube showing the tube in its ambient position.

FIG. 16b is a perspective view of the embodiment shown in FIG. 16a showing the tube in its evacuated position.

FIG. 17a is a perspective view, partly in section, of another embodiment of present invention employing vacuum and spring properties of the walls of a sphere and showing the sphere in its ambient orientation.

FIG. 17b is a perspective view, partly in section, of the embodiment shown in FIG. 17a showing the sphere in its evacuated orientation.

FIG. 18 illustrates embodiment of present invention employing vacuum and multiple springs placed between two large surfaces.

FIG. 19 illustrates the preferred assembly of two vacuum bellows.

FIG. 20 illustrates the preferred assembly of multiple vacuum tubes.

FIG. 21 is a sectional view of assembly of FIG. 20.

FIG. 22 is sectional view of conventional prior art sealed system used as a reference for further comparisons.

FIG. 23 shows the system equivalent to the system of FIG. 22 with reduced cabinet size employing invented dual compressed air-vacuum devices of FIG. 8.

FIG. 24 shows the system equivalent to the system of FIG. 22 with reduced cabinet size employing invented dual vacuum bellow devices of FIG. 19.

FIG. 25 shows the system equivalent to the system of FIG. 22 with reduced cabinet size employing invented multiple vacuum tube devices of FIG. 20. In the drawings like characters of reference indicate corresponding parts in the different figures.

### DETAILED DESCRIPTION OF THE INVENTION

Surface of any object moving or vibrating in air generates sound. In case of conventional loudspeaker, part directly radiating sound is usually referred to as a cone because of its usually conical shape. Some other names like: membrane, diaphragm, dome, radiator or piston can also be found. It can be a surface of rigid object as well as of flexible. Important is surface ability to move air. For the purpose of present analysis the name piston is adopted. This should not by any means limit the scope of present analysis and invention. The name piston is used here to describe any shape, rigid or flexible, capable of displacing air or any other medium.

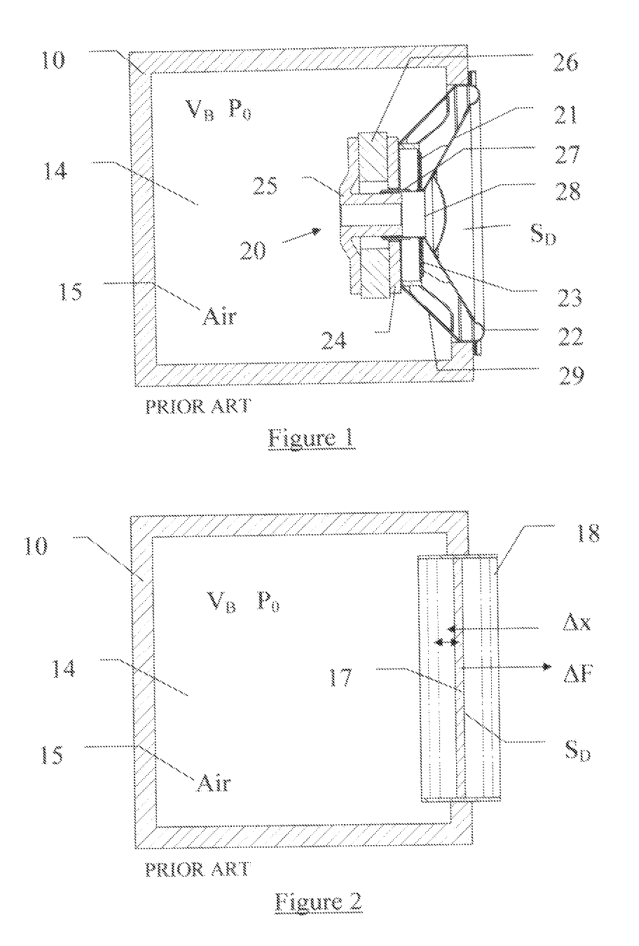

The section of a conventional prior art loudspeaker in sealed enclosure 10 is shown in FIG. 1. Cone 21 of driver 20 having effective area S_{D}, suspended by surround 22 and spider 23, is moved by electromagnetic motor comprising: magnet 26, yoke 25, top plate 24, voice coil 27 and bobbin 28. All components of driver 20 are held together by basket 29. The front surface S_{D} of cone 21 radiates sound and the back surface compresses and expands air 15 inside the internal space 14 of enclosure 10 having internal volume V_{B}. The operation this speaker is well known. The loading effect of the prior art enclosure on transducer 20 can be explained with the reference to FIG. 2. For the simplicity of further analysis cone 21 is represented by piston 17 having the same effective area S_{D} as cone 21 and moving inside sealing tube 18. Static air pressure inside enclosure 10 is the same as outside atmospheric pressure P₀. Any displacement Δx of piston 17 from its rest position generates opposing force ΔF. This force is created by the changes of enclosure internal pressure and piston surface. The relation between displacement Δx and force ΔF is represented by mechanical compliance C_{M}. The mechanical compliance C_{M} can be found knowing acoustic compliance C_{A} of an enclosure and the value of S_{D}. The acoustic compliance C_{A} of an enclosed space having volume V_{B} is expressed by known equation (2).

$${C}_{A} = \frac{{V}_{B}}{ρ \cdot {c}^{2}} \qquad ( 2 )$$

The relation between speed of sound c, gas density ρ and static pressure P is expressed by yet another known equation (3).

$$c = \sqrt{\frac{P \cdot γ}{ρ}} \qquad ( 3 )$$

Where γ is the ratio of specific heats and γ=1.4 for air.

Thus equations (2) and (3) yield

$${C}_{A} = \frac{{V}_{B}}{P \cdot γ} \qquad ( 4 )$$

Equation (4) represents acoustic compliance C_{A} of an enclosed volume V_{B} at any pressure P. Equation (2) was used to derive equation (1). Equation (2) is very popular in all literature related to speakers. However equation (4), directly related to equation (2), is virtually unknown. Equation (4) explains why all efforts of some inventors to find wonderful gas filling enclosure were so fruitless. If P is an ambient pressure that what is left to play with is γ and γ=1.4 for most gasses going down to about 1.1 for FREON.

Transducer cone 21 or equivalent piston 17, coupled to enclosure 10 having compliance C_{A}, exhibits mechanical compliance C_{M} given by known equation (5).

$$\frac{Δ x}{Δ F} = {C}_{M} = \frac{{C}_{A}}{{S}_{D}^{2}} \qquad ( 5 )$$

Mechanical compliance C_{M} represents the ratio of cone displacement Δx to increment ΔF of the force as shown in FIG. 2.

Thus from equations (4) and (5) we have equation (6).

$$\frac{Δ x}{Δ F} = {C}_{M} = \frac{{V}_{B}}{P \cdot γ \cdot {S}_{D}^{2}} \qquad ( 6 )$$

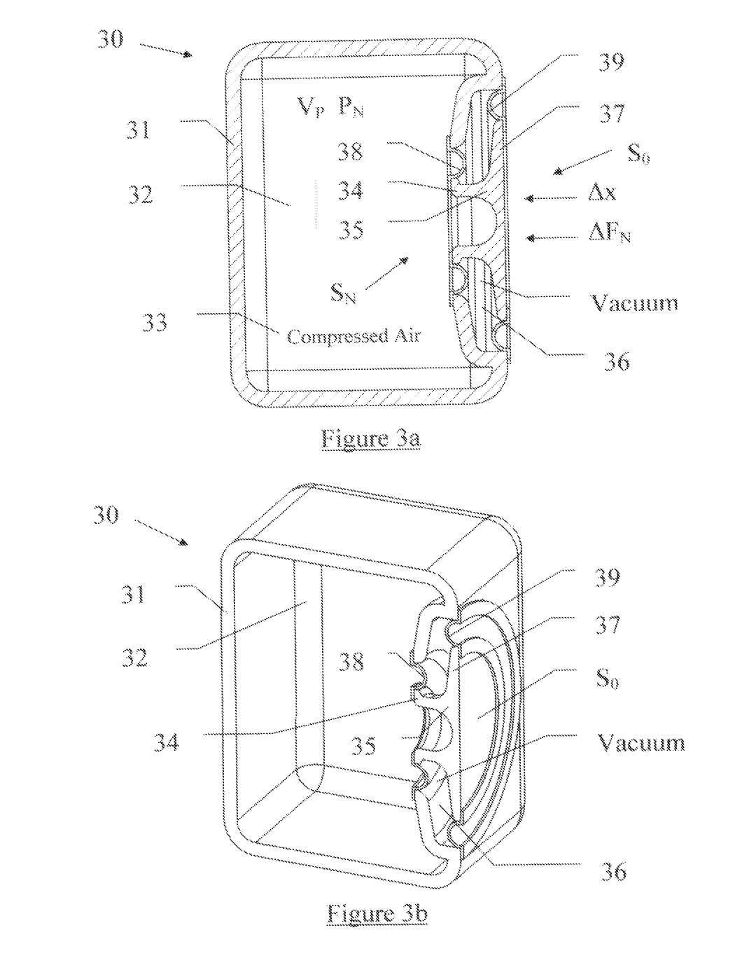

One embodiment 30 of the invented device is shown in FIG. 3a and FIG. 3b. It includes two chambers 32 and 36, two suspensions 38 and 39 and two moving pistons 34 and 37 joined together. Chamber 32 is defined by enclosure walls 31, suspension 38 and piston 34. Chamber 36 is defined by walls 31, suspensions 38 and 39, piston 34 and piston 37. Piston 37 essentially forms a movable wall which has a low pressure side facing the interior of chamber 36 and an ambient side facing the outside environment. Chamber 32 having volume V_{P} is filled with pressurized air 33 and chamber 36 contains a volume of reduced pressure or vacuum. One may call them pressure and vacuum chambers respectively. Piston 34 and movable wall (piston) 37, having surface areas S_{N} and S₀ respectively, are connected through rigid joint 35. Movable wall is biased towards its ambient side by the action of piston 34 being acted on by the pressurized air in chamber 32. Piston 34 and pressure chamber 32 act as a biasing pneumatic spring biasing movable wall 37 such that the movable wall can freely vibrate back and forth between its ambient side and its reduced pressure side.

For the purposes of this application, the word vacuum means that if there is any air left inside vacuum chamber 36, the air pressure is so low that its presence can be neglected. This also means that the value of the internal volume of vacuum chamber 36 has no effect on the system operation and this volume can be made as small as it is only necessary to allow for appropriate mechanical clearance of moving parts. Vacuum chamber 36 may more correctly be referred to as a low pressure (or reduced pressure) chamber, having a volume of reduced pressure relative to the ambient environment. Preferably, the pressure is as low as possible, such as a near vacuum. More preferably, the pressure inside the chamber 36 should be lower than about 80 kPa.

The value P_{N} of the static pressure of the air inside pressure chamber 32 is substantially higher than the atmospheric pressure P₀. For the convenience of further analysis the compression ratio N is defined by equation (7).

$$N = \frac{{P}_{N}}{{P}_{0}} \qquad ( 7 )$$

The value P_{N} of compressed air pressure has to be chosen accordingly to equation (8) where: P₀ is external ambient pressure and S_{N} and S₀ are internal 34 and external 37 piston areas surfaces so the system is in static equilibrium.

P₀·S₀=P_{N}·S_{N} (8)

From (7) and (8) we have equations (9) and (10).

$$\begin{matrix}\frac{{P}_{N}}{{P}_{0}} = \frac{{S}_{0}}{{S}_{N}} & ( 9 ) \\ \frac{{S}_{0}}{{S}_{N}} = N & ( 10 )\end{matrix}$$

Equation (6) can be used to find the mechanical compliance C_{MN} of the gas spring created by pressure chamber 32 and piston 34. It can be done by substituting V_{B} with V_{P}, P with P_{N} and S_{D} with S_{N} what leads to equation (11).

$${C}_{MN} = \frac{{V}_{P}}{{P}_{N} \cdot γ \cdot {S}_{N}^{2}} \qquad ( 11 )$$

FIG. 3a and FIG. 3b show that piston 34 and movable wall 37 are connected through rigid join 35. Their movement can be described then by common mechanical compliance C_{MN}. The changes of the volume of vacuum chamber 36 do not generate any forces. Acoustical compliance C_{AN} at the opening of piston 37 in FIG. 3 is then given by equation (12) similar to equation (5).

C_{AN}=C_{MN}·S₀² (12)

Equations (11) and (12) yield

$${C}_{AN} = \frac{{V}_{P} \cdot {S}_{0}^{2}}{{P}_{N} \cdot γ \cdot {S}_{N}^{2}} \qquad ( 13 )$$

Equations (8), (10) and (13) give equations (14) and (15).

$$\begin{matrix}{C}_{AN} = \frac{{V}_{P}}{{P}_{0} \cdot γ} \cdot N & ( 14 ) \\ {C}_{AN} = {C}_{A 0} \cdot N & ( 15 )\end{matrix}$$

C_{A0} in equation (15), accordingly to equation (4), is the acoustical compliance of pressure chamber 32 at atmospheric pressure P₀.

Equation (15) represents the fundamental property of invented device 30. It says that the device acoustical compliance C_{AN}, seen at the exposed (ambient) side of movable wall 37, is magnified by the ratio of pressures N. It looks like device physical volume is increased N times.

Now, it can also be easily shown that

$$\frac{Δ x}{Δ {F}_{N}} = {C}_{MN} = {C}_{M 0} \cdot N \qquad ( 16 )$$

Where: C_{M0} is the mechanical compliance of device 30 assuming conventional, prior art operation, at atmospheric pressure P₀.

And also

$$Δ {F}_{N} = \frac{Δ {F}_{0}}{N} \qquad ( 17 )$$

Equation (17) says that the force needed to move wall 37 is now N times smaller than it would be if the same enclosure volume was used in a conventional way. This reduces electrical power and magnet size of a transducer needed to move it. It is important to notice that the acoustical compliance C_{AN}, seen at the exposed side of wall 37, does not depend on the values of the surface areas S₀ and S_{N} but on their ratio N as it is shown in equation (14).

For the convenience of further analysis one may define the concept of Equivalent Acoustic Volume of a device—V_{AE}. It is the volume of air under normal condition having the same acoustic compliance as acoustic compliance of a device. The concept of the equivalent acoustic volume is widely used to describe compliance of loudspeaker suspensions, as an example, and it uses symbol V_{AS}.

For any conventional enclosure or cavity filled with ambient air:

V_{A}=V_{B} (18)

And for invented device:

V_{AE}=V_{P}·N (19)

The present analysis did not take into account the compliance of suspensions 38 and 39. In practice suspensions 38 and 39 reduce slightly resultant acoustical compliance. Moreover the walls of invented device occupy certain space so the vacuum chamber does. If one define V_{T} as the total volume of space occupied by invented device then after taking all these factors into consideration

V_{T}<<V_{AE}<V_{T}·N (20)

It is not practical limitation because all losses in equivalent compliance can be compensated by using higher pressure expressed by N and there are no real difficulties in making suspensions sufficiently compliant. There is also assumption that there is perfect vacuum inside vacuum chamber. If however there is some gas left inside it would act as additional compliance similar to suspension compliance.

Suspensions 38 and 39 also participate in displacing air and radiating sound. The calculation of radiating surface S₀ should include the portion of suspension 39 as well as surface S_{N} should include the portion of suspension 38 areas. This procedure is understandable for all skilled in art and all examples which follow assume that.

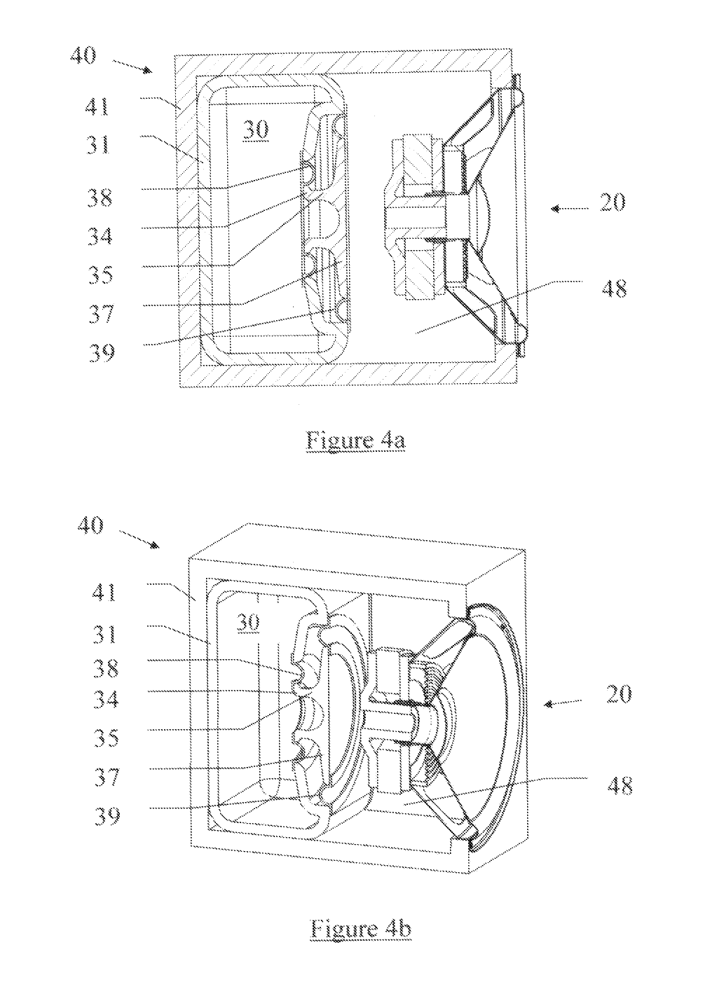

The example of practical application of invented device 30 is shown in FIG. 4a and FIG. 4b. Device 30 is placed inside enclosure 41 of sealed system 40 comprising driver 20. The placement of invented device 30 inside enclosure 41 increases its acoustic compliance. It is that because acoustic compliance of device 30 is multiple times larger that the acoustic compliance of the air space this device displaces. See equation (20). In consequence system 40 operates as a system with much larger volume than it is indicated by its physical dimensions, increasing its efficiency and improving performance.

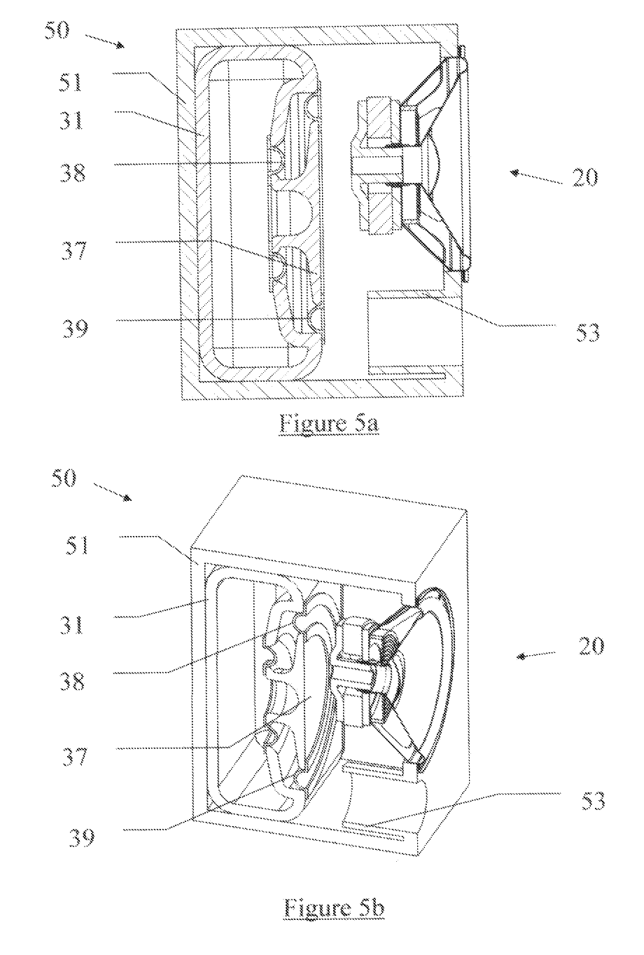

Invented device can be used to improve efficiency and performance of absolutely any known loudspeaker or acoustic system. FIG. 5a and FIG. 5b shows its application in vented system 50.

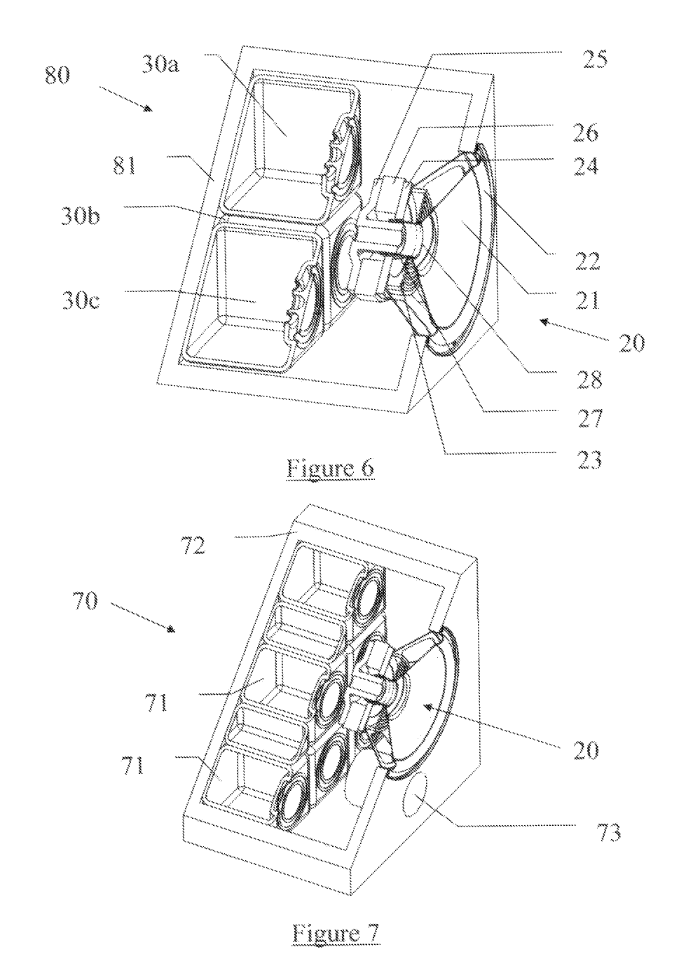

Invented device can have different shapes. What counts is its equivalent acoustic volume V_{AE}. Those skilled in art would notice that the resultant compliance of multiple devices is the sum of individual compliances or equivalent volumes. One larger device can be substituted by four smaller each having the quarter of original volume, as an example. FIG. 6 shows sectional view of sealed system 80 with four invented devices 30 and FIG. 7 is a vented system 70 employing nine invented devices 71.

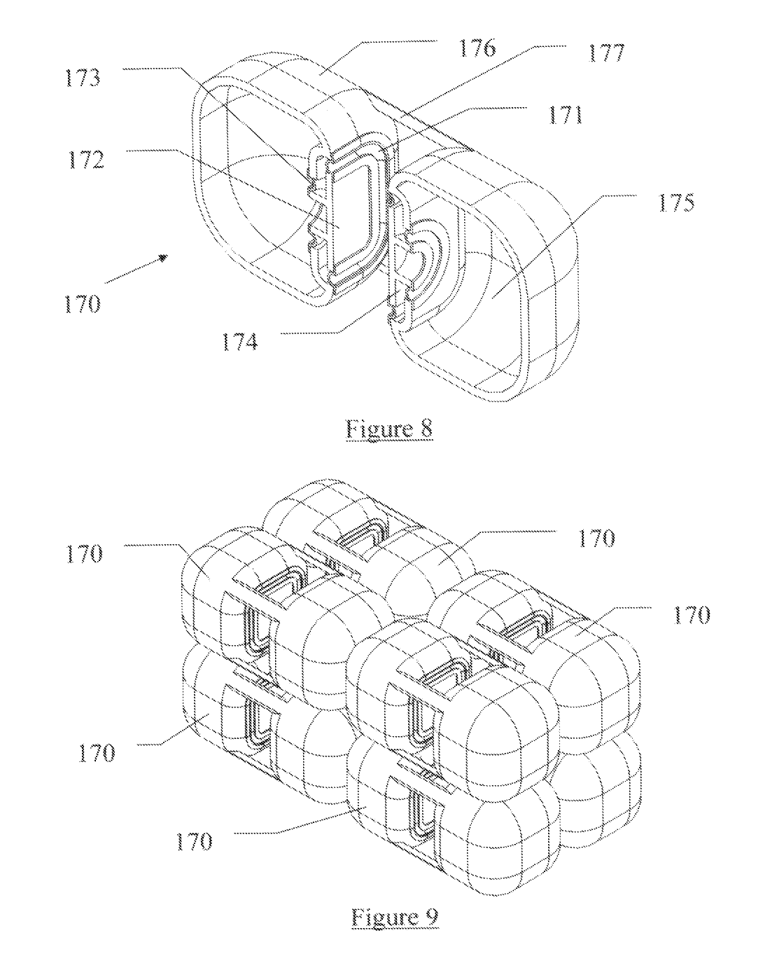

There are many advantages of dividing larger device into smaller pieces even though the total V_{AE} being the sum of individual V_{AE} stays the same. Those skilled in art should notice that the increase in overall compliance of the box volume contributed to the use of this invention happens only below the resonance frequency of device compliance and mass of moving pistons. It is then desirable to have this resonance frequency as high as possible. In addition the high pressure of air inside pressure chamber imposes certain strength requirements on walls and other element of devices construction. Thus dividing one larger device into smaller pieces addresses all these issues simultaneously. It also helps to use the internal space of an enclosure more economically. Very small devices can be placed in multiple layers to fill the space. It has to be done so moving parts have enough space during operation. In addition all moving parts including driver must be able to communicate through the air inside enclosure. One of possible arrangements is shown in FIG. 8. Invented element is assembled to form dual capsule 170. The capsule has walls 176 with rounded corners. It comprises two vacuum chambers 174, two pressure chambers 175 connected through four joints 177 and two piston assemblies 172 facing each other and suspended by surrounds 171 and 173. Capsules 170 can be glued together in many different ways and thanks to their rounded shapes there is always space between them allowing for the free flow of air. The example of larger assembly of capsules 170 is shown in FIG. 9.

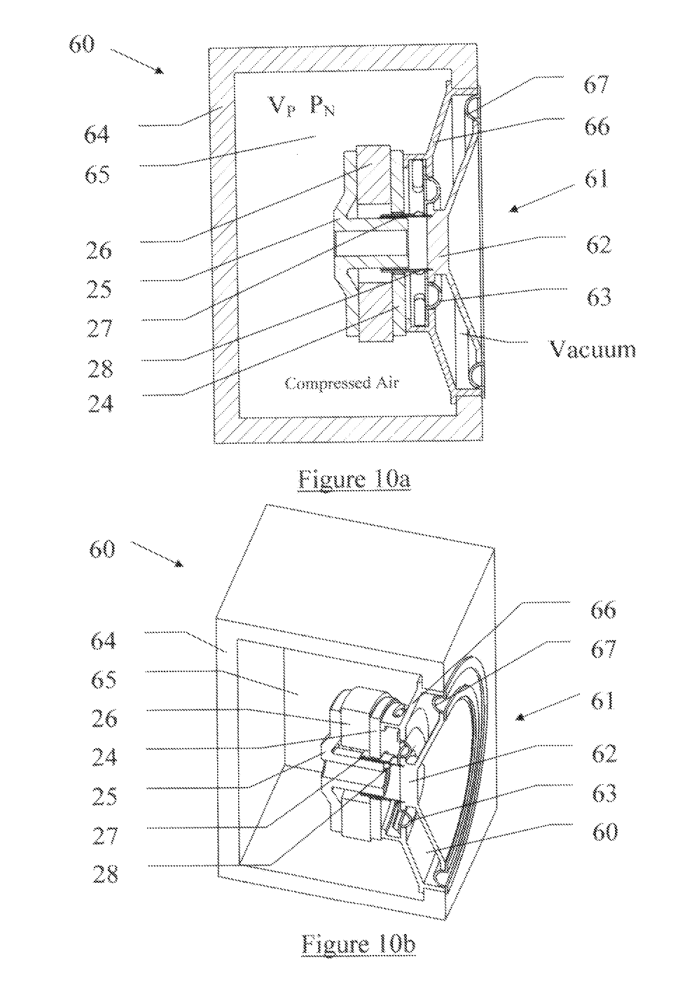

The invented device can also constitute the part of driver 61 in sealed system 60 as it is shown in FIG. 10a and FIG. 10b. Interior 65 of air tight cabinet 64 is filled with compressed air. Basket 66 of driver 61 is also air tight without usual openings. Strong and rigid cone 62 is suspended by two surrounds 63 and 67. Surround 63 and 67, basket 66 and cone 62 are the boundaries of vacuum chamber 60. The motor of driver 61 comprises usual components: magnet 26, yoke 25, top plate 24, bobbin 28 and voice coil 27. The advantage of this solution is that there are no additional moving parts, like pistons or cones in case implementing capsules 170, as an example, so the system behaves very conventional way. In this case the design procedure is also conventional except that the volume of the cabinet reduces N times.

The invented device can also be the part of passive radiator system 70 what is illustrated in FIG. 11a and FIG. 11b. There is also air tight basket 72 there. Vacuum chamber is created by basket 72, surrounds 71 and 73 and cone 74. Driver 61 has the same construction as in example from FIG. 10. Cone 62 of driver 61 and cone 74 of passive radiator 79 have two surfaces each. Larger surfaces are exposed to external environment and smaller to internal pressurized air. The ratios of larger to smaller surfaces should be equal to compression ratio N. Other than that the design procedure is conventional. The advantage of this approach is again substantially reduced system size.

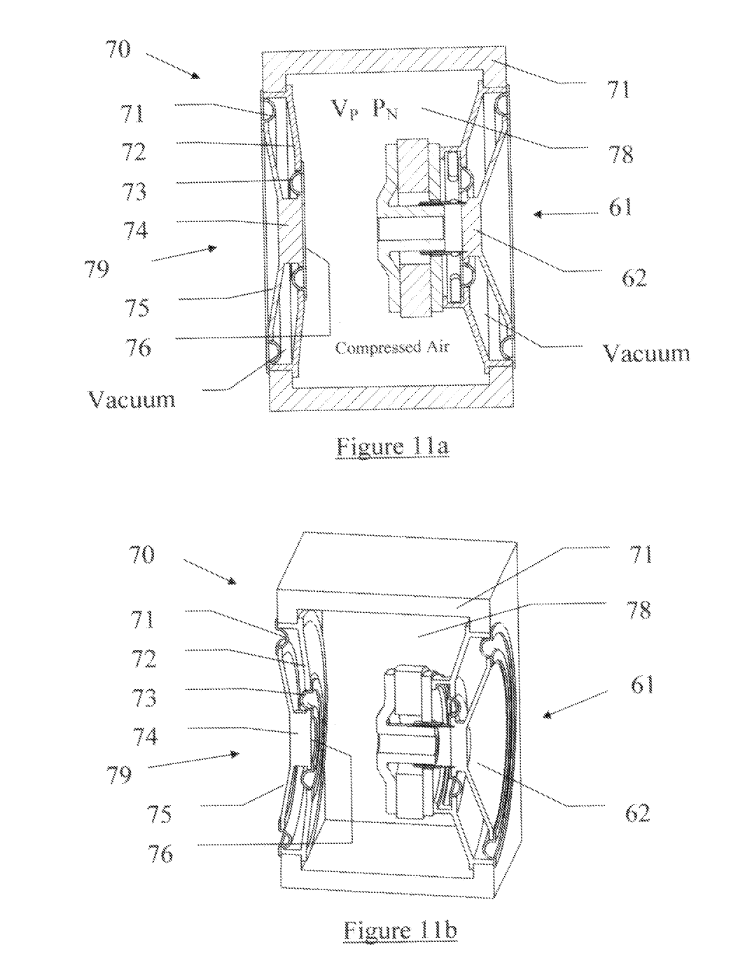

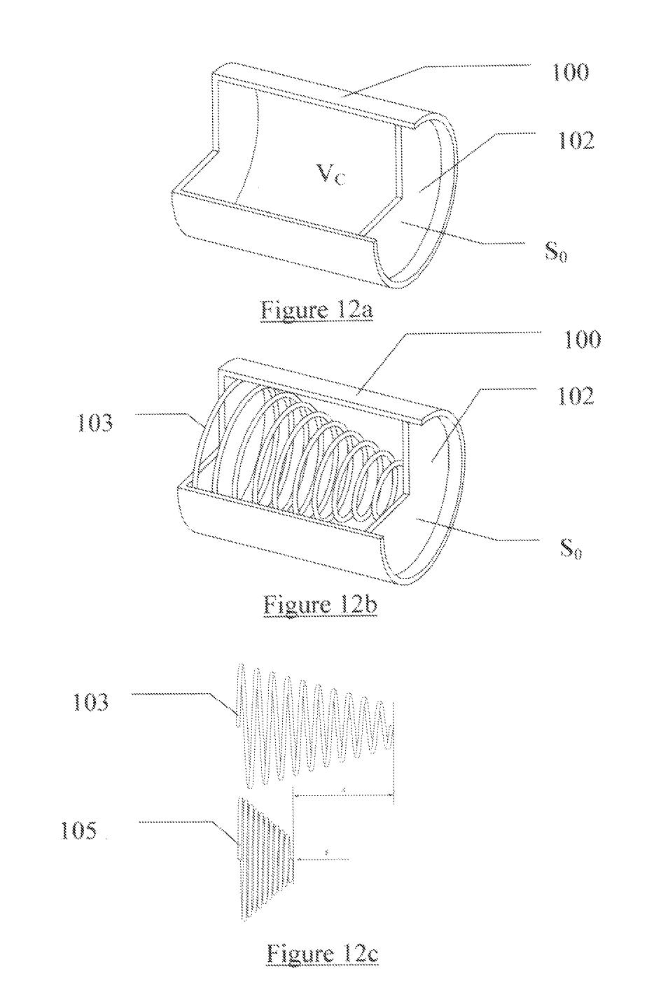

Compressed air works like a spring and can be substituted by a mechanical spring. Lets then consider cylinder 100 with one movable side or piston 102 what is illustrated in FIG. 12a. The cylindrical shape is used as an example and does not impose any limitation on generality of further analysis. Acoustic compliance seen at the surface of piston 102 at the end of cylinder 100 having volume V_{C} and filled with air under normal condition agrees with equations (2) and (4). FIG. 12b shows cylinder 100 with spring 103 inside. Force F applied to spring 103 having constant C_{M} reduces spring total length by distance x and spring changes its shape to become 105 what is illustrated in FIG. 12c. The relation between force F, distance x and spring constant C_{M} is expressed by known equation (21).

x=C_{M}·F (21)

If air is removed from inside of cylinder 100 containing spring 103 in FIG. 12b and vacuum is created then force F produced by atmospheric pressure P₀ and surface S₀ of piston 102 compresses spring to have shape 105. Cylinder 100 can now be shortened to become cylinder 104 what is shown in FIG. 13. The value of force F is given by equation (22).

F=S₀·P₀ (22)

Equations (21) and equation (22) yield equation (23).

x=C_{M}·S₀P₀ (23)

Thus spring constant C_{M} needs to have value (24)

$${C}_{M} = \frac{x}{{S}_{0} \cdot {P}_{0}} \qquad ( 24 )$$

Acoustic compliance C_{A} seen at the surface of piston 102 at the end of cylinder 104 filled with vacuum, containing spring 105 and shown in FIG. 13 is then given by equation (25) similar to equation (12).

C_{A}=C_{M}·S₀² (25)

Thus equations (24) and (25) yield equation (26).

$${C}_{A} = \frac{x \cdot {S}_{0}}{{P}_{0}} \qquad ( 26 )$$

The internal volume of cylinder 104 is V_{CS} in FIG. 13. Distance x is the distance piston 102 shifted after vacuum is created. This yields to equation (27).

x·S₀=V_{C}−V_{CS} (27)

and equation (28)

$${C}_{A} = \frac{{V}_{C} - {V}_{CS}}{{P}_{0}} \qquad ( 28 )$$

One may apply the concept of Equivalent Acoustic Volume—V_{AE} to this case. Equations (28) and (4) give equation (29).

$${C}_{A} = \frac{{V}_{C} - {V}_{CS}}{{P}_{0}} = \frac{{V}_{AE}}{{P}_{0} \cdot γ} \qquad ( 29 )$$

and equation (30)

V_{AE}=(V_{C}−V_{CS})·γ (30)

Equation (30) demonstrates that element 110 from FIG. 13 has substantially and multiple times larger acoustic compliance than the air having the same volume as overall volume of this element. There is additional gain of using mechanical spring versus gas spring. This gain is equal to γ=1.4.

Equation (30) has very general meaning and applications. The spring constant, C_{M}, should maximize the benefits of this invention and be chosen so

V_{AE}>>V_{CS} (31)

It is also possible to have larger structures with multiple springs 164 what is illustrated in FIG. 18.

There is yet another very important conclusion evolving from equations (19) and (30). Both embodiments whether with air spring or mechanical spring need vacuum chamber. Vacuum in cooperation with ambient atmospheric pressure and devices movable surfaces or pistons create forces compressing air inside pressure chamber or compressing spring. Let assume that vacuum chamber looses its vacuum in both cases and fills with normal air then compressed air or gas and spring will expand. The compressed air filling volume V_{P} now takes space N times larger. Similarly spring moves piston 102 so cylinder internal volume, assuming longer cylinder, is now V_{C}. One can notice now than acoustic compliance of invented device in both embodiments is very close to acoustic compliance of hypothetical air space device would take after filling vacuum with ambient air. This observation helps to understand the functioning of many other possible variations of invented device.

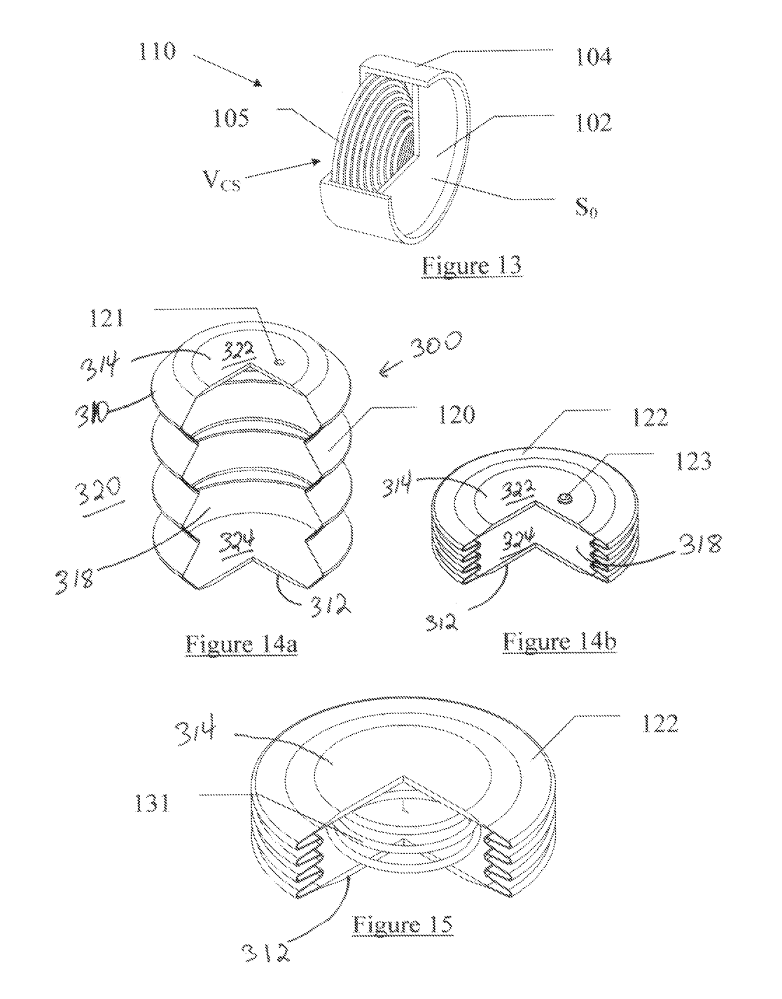

A preferred embodiment of the present invention which uses a mechanical spring is shown in FIG. 14a and FIG. 14b. In this case, the acoustic compliance device, shown generally as item 300, includes a housing 310 which forms a bellow. Housing 310 has movable walls 312 and 314, intermediate wall portions 120 and hollow interior 318. Housing 310 is made of a highly resilient material, such as steel, which is formed in an expanded position as shown in FIG. 14a when interior 318 is equal in pressure to the ambient air 320 outside the housing. After removing air from inside chamber 318 through hole 121, bellow 300 shrinks to have shape 122 as shown in FIG. 14b. With bellows 300 thus evacuated, interior 318 becomes a vacuum chamber enclosing a volume of reduced pressure. Movable walls 312 and 314 each have an ambient side 322 which faces the ambient air outside the bellows (320) and a low pressure side 324 facing the volume of reduced pressure inside low pressure chamber 318. Housing 310, and in particular intermediate wall portions 120, act as a biasing spring and bias movable walls 312 and 314 away from interior 318 and towards the ambient outside air 320. Since ambient sides 322 are facing the environment, they are acoustically coupled to the outside, meaning that acoustical vibrations traveling in the ambient environment can impinge on the movable walls. The thickness of housing 310 and the resilience of the material forming housing 310 is selected such that the biasing force exerted by housing 310 is sufficient to permit movable walls 3f14 and 312 to vibrate freely in response to acoustical vibrations impinging on the movable walls from the ambient environment 320. Bellows 300 can therefore transmit acoustical vibrations. The acoustic compliance of bellow 122 (in FIG. 14b) is close to the compliance of air having the volume of internal volume of bellow 120 (as seen in FIG. 14a).

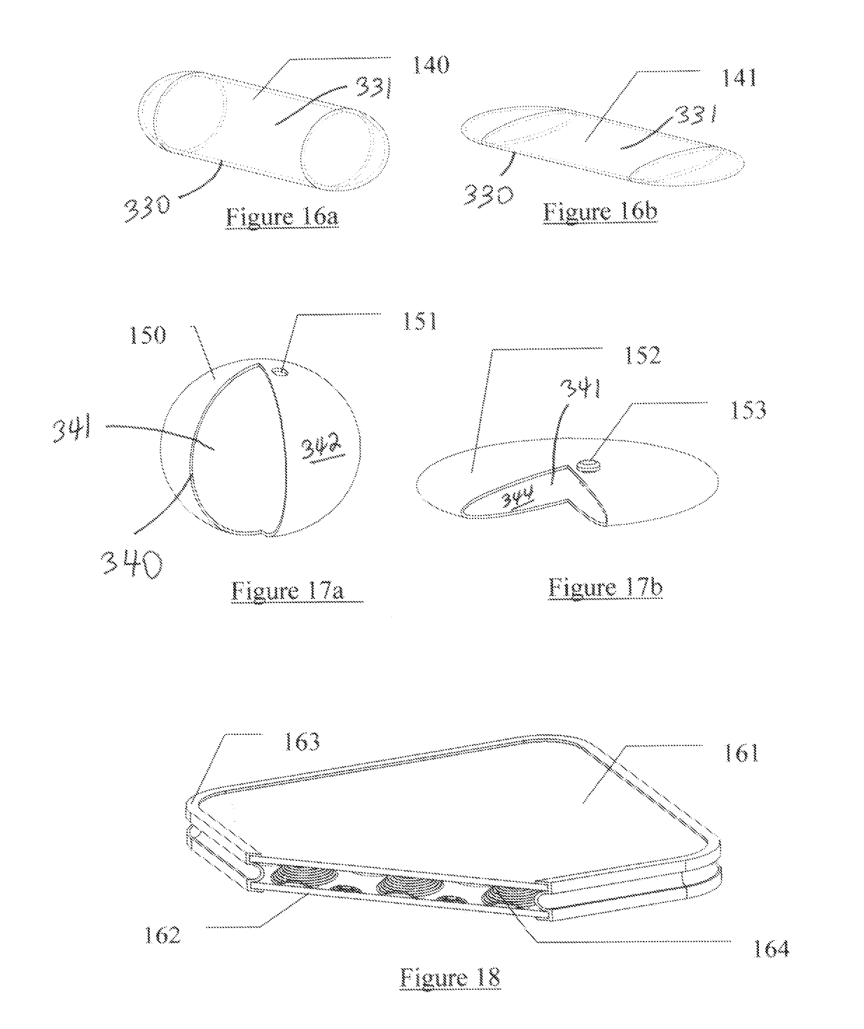

In another example the bellow 122 has weaker walls and is reinforced by internal spring 131 as it is shown in FIG. 15. Other equivalent possibilities with different shapes are presented in FIG. 16 and FIG. 17. In FIG. 16a, a tubular housing 330 is formed from a highly resilient material. Tubular housing 330 has an interior 331 and has a cylindrical shape 140 when the pressure inside interior 331 equals the pressure outside housing 330. When housing 330 is evacuated to remove all (or most) of the air from interior 331, the housing air pressure outside housing 330 causes the housing to be flattened as shown in FIG. 16b. The thickness and resiliency of housing walls 330 is selected to bias housing walls away from interior 331 sufficiently to permit the walls to vibrate in response to acoustical vibrations impinging on the housing from outside. The walls of the housing essentially act like a mechanical spring.

Likewise, FIG. 17a shows a similar embodiment which takes the form of a sphere rather than a tube or bellow. Again, the device consists of a housing wall 340 which is made of a highly resilient material which is formed as a sphere having a hollow interior 341. Air is evacuated from interior 341 so that the device takes on the shape of a flattened sphere 152 as shown in FIG. 17b. As in the previous examples, the resilience of the housing walls 340 act as biasing springs keeping the walls oriented such that they can vibrate in response to acoustical vibrations in the environment. The housing walls 340 act as both spring and as movable walls, and each has an ambient side 342 facing the ambient environment and a low pressure side 344 facing interior 341.

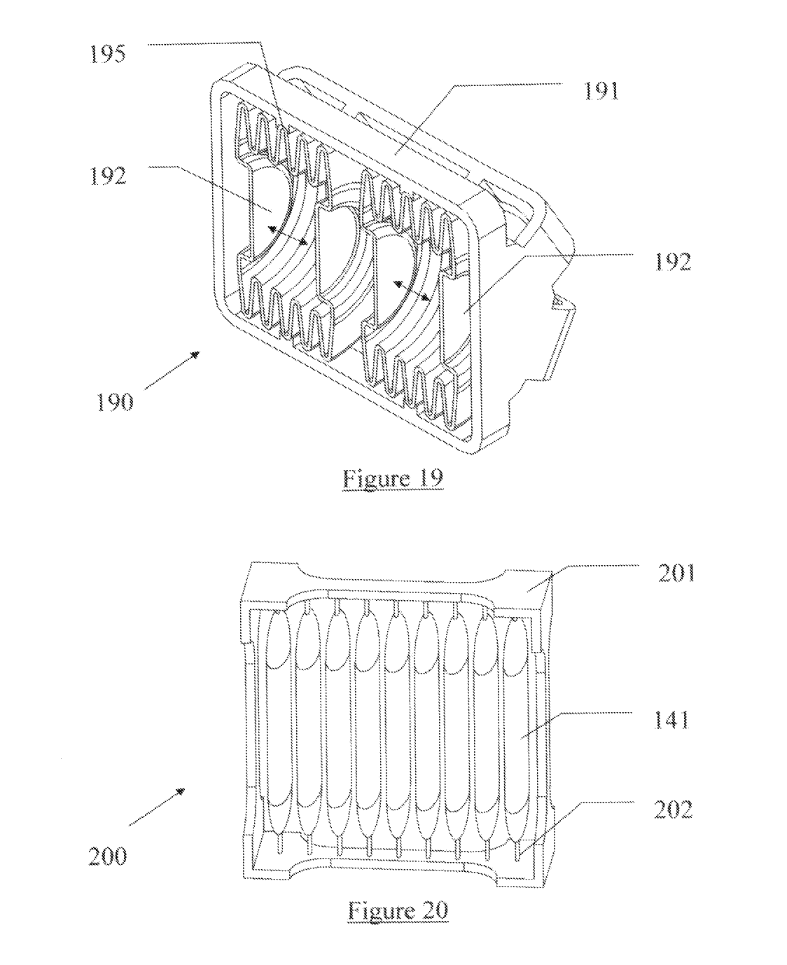

The devices employing mechanical spring also benefit from dividing them into smaller devices and using them in larger quantities. FIG. 19 is a sectional and perspective view of dual assembly 190 of vacuum bellows 192. The bellows 192, mounted inside holder 191, are supported in the middle 195 what increases their self resonance frequency even further.

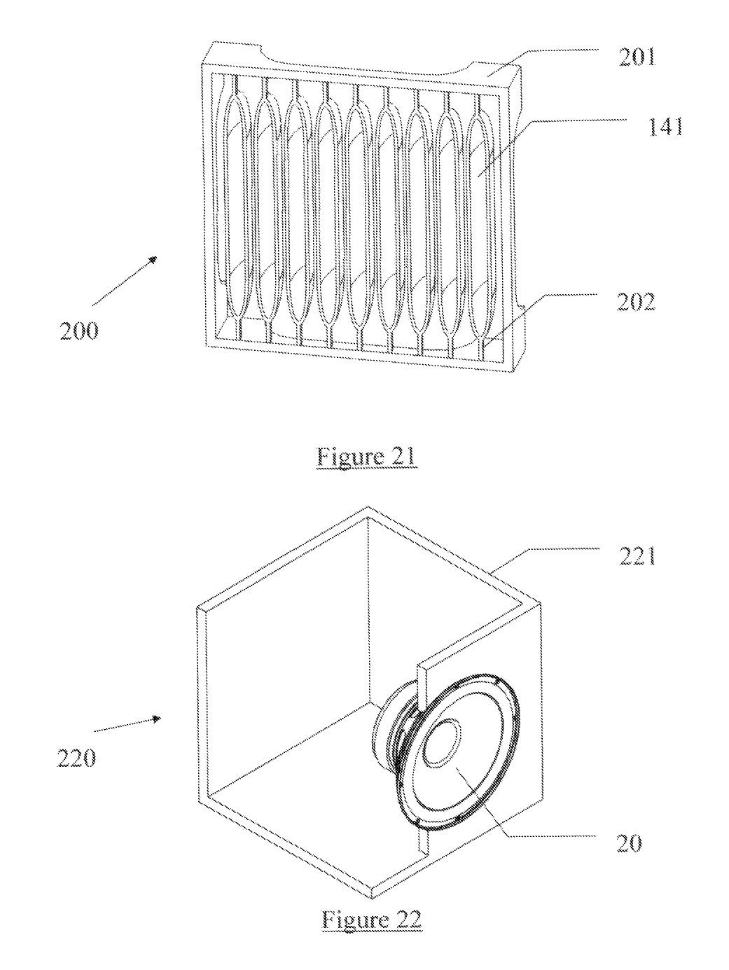

Smaller devices like vacuum tubes 141 can be assembled to form module 200 like it is illustrated in FIG. 20 and FIG. 21. Frame 201 holds nine tubes 141 suspended by flexible joints 202.

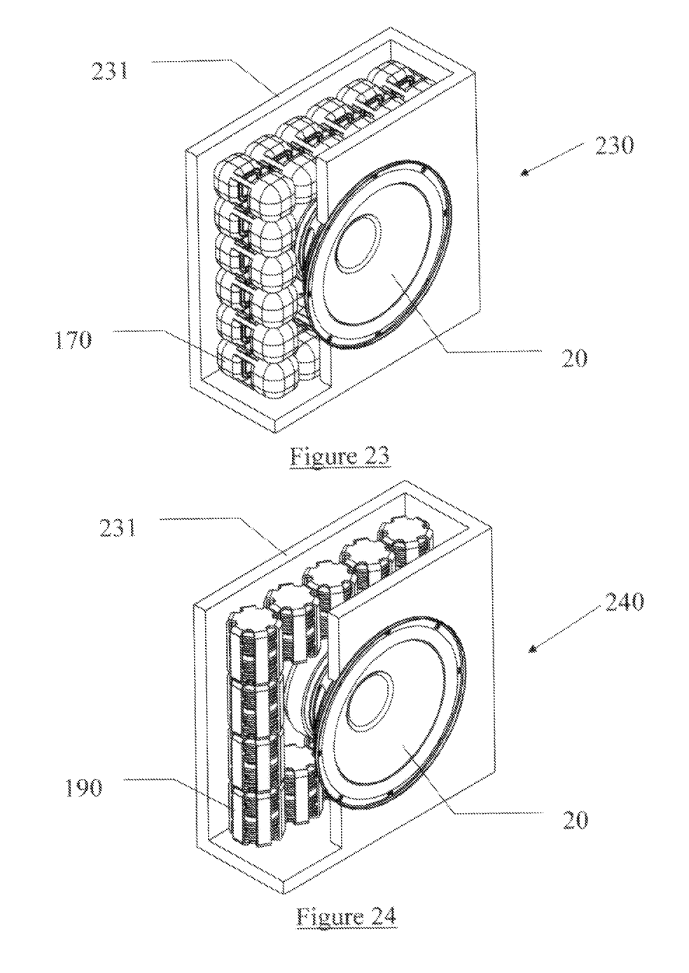

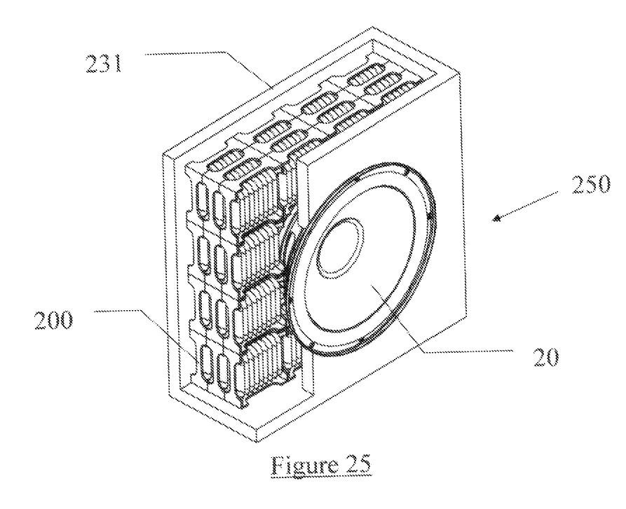

FIG. 22 shows the section of conventional sealed box system 220 comprising enclosure 221 and driver 20. The example illustrated in FIG. 23 shows sealed system 230 after implementing twenty invented compressed air dual devices 170. Enclosure 231 can now have substantially reduced size. Similarly the example from FIG. 24 uses fourteen vacuum bellow dual devices 190. And another example in FIG. 25 employs thirty six vacuum tube modules 200 totaling 324 individual vacuum tubes 141.

Sealed box system is used as an example. Similar reduction of the system size is achievable for vented systems as well as for all other known systems.

For known reasons the static ambient atmospheric pressure varies. This pressure variation may offset the center position of some moving elements beyond acceptable limits. To compensate for this phenomenon, if it is necessary, small heating element may be inserted into compressed gas chamber. The local variations of atmospheric pressure are usually not larger than ±5%. Thus required compressed gas temperature variations are about ±15° C. or ±27° F. This heating element should also keep the gas temperature slightly above ambient to avoid the need for cooling. The heating element is then controlled by the device sensing the position of chosen components. If mechanical spring is used instead of gas spring then the same technique can be implemented using thermal expansion of device components. The design of such a system is routine engineering task and is not described here. It should be noticed that this ambient pressure compensating system is not necessary for the basic functioning of this invention.

There are not any advantages of using any other gas than air inside gas springs. The only possible advantage of using other gasses is small reduction in constant γ and only if some hazardous gasses like Freon is used. The other practical option is nitrogen.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A device for use in acoustic systems in an environment, said device comprising:
a) a low pressure chamber containing a volume of reduced pressure relative to the environment;
b) a movable wall having an ambient side acoustically coupled to the environment and a low pressure side acoustically coupled to the low pressure chamber,
c) the movable wall being sufficiently biased towards the ambient side to permit the movable wall to freely vibrate between the ambient and low pressure sides.

2. The device of claim 1 wherein the low pressure chamber contains a gas other than air.

3. The device of claim 1 wherein the pressure inside said low pressure chamber is less than about 80 kPa.

4. The device of claim 1 wherein the movable wall is biased by a mechanical spring.

5. The device of claim 1 wherein the movable wall is biased by a gas spring.

6. The device of claim 5 wherein the gas spring comprises a gas chamber having a volume of increased gas pressure relative to the environment and a piston coupled to the movable wall, the piston having a high pressure side and a low pressure side, the high pressure side of the piston being acoustically coupled to the gas chamber and the low pressure side of the gas piston being acoustically coupled to the low pressure chamber.

7. The device of claim 1 wherein the movable wall is mechanically coupled to an electro-acoustic transducer.

8. The device of claim 1 wherein the low pressure chamber has a housing and wherein the movable wall is formed on the housing.

9. The device of claim 8 wherein the low pressure chamber contains a biasing spring for biasing the movable wall.

10. The device of claim 8 wherein the housing is made of a resilient material and is configured to form a biasing spring for biasing the movable wall.

11. A device for propagating acoustic vibrations through an environment and having an increased acoustic compliance, said device comprising:
a) a low pressure chamber containing a volume of reduced pressure relative to the environment;
b) a movable wall formed on the low pressure chamber, said movable wall having an ambient side facing the environment and a low pressure side facing the volume of reduced pressure,
c) the movable wall being sufficiently biased towards the environment and away from the volume of reduced pressure such that the movable wall can freely vibrate back and forth relative to the volume of reduced pressure in response to acoustic vibrations impinging on the ambient side of the movable wall.

12. The device of claim 11 wherein the chamber is formed from a housing made of a resilient material, the movable wall being formed on the housing, a portion of the housing acting as a spring to bias the movable wall away from the volume of reduced pressure.

13. The device of claim 12 wherein the chamber comprises a hollow envelope, the volume of reduced pressure comprising a hollow interior of the envelope, the envelope having opposite walls coupled together by an intermediary portion, movable wall being one of said opposite walls, the intermediary portion being configured as a spring to bias the movable wall away from the hollow interior.

14. The device of claim 13 wherein the envelope takes the form of a bellows having opposite movable walls.

15. The device of claim 14 wherein the bellows further comprises a coil compression spring positioned in the interior, said coil compression spring bearing against both movable walls and applying a biasing force against them.
